(19) United States
(12) Patent Application Publication
(10) Pub. No.: US 2026/0350538 A1
(43) Pub. Date: Nov. 5, 2026

(54) SYSTEMS AND METHODS FOR IMPLEMENTING MACHINE LEARNING TECHNIQUES FOR REPORT GENERATION

(71) Applicant: Fidelity Information Services, LLC, Jacksonville, FL (US)

(72) Inventors: Kieron PATERSON, Sydney (AU); Angad BAGGA, Mohali (IN); Gopal PADHI, Pune (IN); Julia DEMIDOVA, London (GB); Mayur SHIRADHONKAR, Pune (IN); Sudhanshu SHUKLA, Bengaluru (IN); Joel Earl DAKE, Hubertus, WI (US); Gowtham Gyarahalli MALLAIAH, Bengaluru (IN)

(73) Assignee: Fidelity Information Services, LLC, Jacksonville, FL (US)

(21) Appl. No.: 19/662,972

(22) Filed: Apr. 29, 2026

Related U.S. Application Data
(60) Provisional application No. 63/798,183, filed on May 1, 2025.

(51) Int. Cl. G06Q 10/10; G06N 20/00

(52) U.S. Cl. CPC G06Q 10/10; G06N 20/00

(57) ABSTRACT

A computer-implemented method for report generation, the method including receiving, from a user, a request to generate a report, determining, by one or more processors, whether the request received is a valid request, executing, by the one or more processors, at least one of a lexical search and a vector search of the request on a knowledge based storage database to determine a relevant data object, generating, by a machine learning model, a client report based on the relevant data object, and transmitting, to a user interface by the one or more processors, the client report.

### CROSS-REFERENCE TO RELATED APPLICATIONS

This application claims priority to, and the benefit of, U.S. Provisional Patent Application No. 63/798,183, filed May 1, 2025, which is hereby incorporated by reference in its entirety for any and all purposes.

### TECHNICAL FIELD

Various embodiments of this disclosure relate generally to artificial intelligence and machine-learning-based techniques for document generation, in particular various aspects relate to machine learning techniques of report generation related to the management of electronic transactions and accounts.

### BACKGROUND

Administrators of computing systems may face challenges in analyzing and taking actions based on data related to such computing systems. In some cases, administrators may risk exposure because of an inability to timely analyze and act upon data in real-time.

For example, financial institutions and treasury management systems may generate large volumes of transaction data, policy documents, and knowledge base articles that require analysis and reporting. Conventional approaches to document and report generation often require manual review of extensive documentation, which can be time-consuming and error-prone.

Traditional systems for generating reports based on transaction data and policy documents may lack the ability to efficiently search and retrieve relevant information from large knowledge bases. Furthermore, conventional approaches may not effectively incorporate user session history or context when generating responses to user queries. These limitations can result in inconsistent report generation, increased processing time, and reduced accuracy in applying policies and rules to user-specific data.

Additionally, existing systems may not adequately address content safety concerns when processing user requests, potentially allowing harmful or inappropriate content to be processed. There is a need for improved systems and methods that can efficiently generate reports by leveraging machine learning techniques, knowledge base searching, and session management while maintaining content safety standards.

Unless otherwise indicated herein, the materials described in this section are not prior art to the claims in this application and are not admitted to be prior art, or suggestions of the prior art, by inclusion in this section.

### SUMMARY OF THE DISCLOSURE

In some aspects, the techniques described herein relate to a computer-implemented method for report generation, the method including: receiving, from a user, a request to generate a report; determining, by one or more processors, whether the request received is a valid request; executing, by the one or more processors, at least one of a lexical search and a vector search of the request on a knowledge based storage database to determine a relevant data object; generating, by a machine learning model, a client report based on the relevant data object; and transmitting, to a user interface by the one or more processors, the client report.

In some aspects, the techniques described herein relate to a computer-implemented method, further including: determining whether a similar request has been previously received by the one or more processors, based on a request history; and upon determining that the request has been previously been received, executing the at least one of the lexical search and the vector search is bypassed, and a previously generated client report is retrieved and transmitted as the client report.

In some aspects, the techniques described herein relate to a computer-implemented method, further including: determining whether the user has made a previous request to generate a report; if a previous request was generated, retrieving a session history from storage; and providing the session history to the machine learning model, the machine learning model incorporating the session history when generating the client report.

In some aspects, the techniques described herein relate to a computer-implemented method, wherein upon a determination that the user has not made a previous request to generate the client report, creating a new session for the user.

In some aspects, the techniques described herein relate to a computer-implemented method, wherein executing the at least one of the lexical search and the vector search further includes: generating, by the machine learning model, a search query based on the request and any past requests from the user, wherein the machine learning model uses the search query to perform the lexical search and vector search.

In some aspects, the techniques described herein relate to a computer-implemented method, wherein if the lexical search and vector search of the request on the knowledge based storage database returns no result, transmitting to the user interface a response indicating no answer can be found and not transmitting the client report.

In some aspects, the techniques described herein relate to a computer-implemented method, further including: identifying a count of how many time the request or a similar request has been made to the one or more processors; and if the count exceeds a threshold value, storing the request with the associated client report to the knowledge based database.

In some aspects, the techniques described herein relate to a computer-implemented method, further including: requesting a feedback response from the user about the client report after the transmitting the client report.

In some aspects, the techniques described herein relate to a computer-implemented method, wherein determining whether the request received is a valid request includes determining whether the request includes harmful content.

In some aspects, the techniques described herein relate to a computer-implemented method, wherein the determining whether the request includes harmful content includes identifying text in the request related to sex, hate, self-harm, or violence.

Additional objects and advantages of the disclosed aspects will be set forth in part in the description that follows, and in part will be apparent from the description, or may be learned by practice of the disclosed aspects. The objects and advantages of the disclosed aspects will be realized and attained by means of the elements and combinations particularly pointed out in the appended claims.

It is to be understood that both the foregoing general description and the following detailed description are exemplary and explanatory only and are not restrictive of the disclosed aspects, as claimed.

### BRIEF DESCRIPTION OF THE DRAWINGS

The accompanying drawings, which are incorporated in and constitute a part of this specification, illustrate various exemplary aspects and together with the description, serve to explain the principles of the disclosed aspects.

FIG. 1 depicts an exemplary environment for using a machine-learning model for rules-based modeling, according to one or more embodiments.

FIG. 2 depicts an exemplary environment implementing a machine learning model to generate a user response, according to one or more embodiments.

FIG. 3 depicts a flow diagram for implementing a machine learning model to generate a user response, according to one or more embodiments.

FIG. 4 depicts a flow diagram of an exemplary method for report generation, according to one or more embodiments.

FIG. 5 depicts a flow diagram for a frequently asked questions (FAQ) management system, according to one or more embodiments.

FIG. 6 depicts a flow diagram for policy document generation, according to one or more embodiments.

FIG. 7 depicts a flow diagram for uploading policies, rules, and/or KB articles to the system described herein , according to one or more embodiments.

FIG. 8 depicts a flow diagram of an exemplary technology diagram, according to one or more embodiments.

FIG. 9 depicts a user interface of a request input form, according to one or more embodiments.

FIG. 10 depicts a user interface for a subsection creation request, according to one or more embodiments.

FIG. 11 depicts a user interface for an image creation request, according to one or more embodiments.

FIG. 12 depicts a user interface of a table creation request, according to one or more embodiments.

FIG. 13 depicts a user interface of a policy export request, according to one or more embodiments.

Notably, for simplicity and clarity of illustration, certain aspects of the figures depict the general configuration of the various embodiments. Descriptions and details of well-known features and techniques may be omitted to avoid unnecessarily obscuring other features. Elements in the figures are not necessarily drawn to scale; the dimensions of some features may be exaggerated relative to other elements to improve understanding of the example embodiments.

### DETAILED DESCRIPTION

Various embodiments of this disclosure relate generally to artificial intelligence and machine-learning-based techniques for document generation, in particular various aspects relate to machine learning techniques of report generation related to the management of electronic transactions and accounts.

The systems and methods described herein may generate one or more documents for a user based on a user request. For example, a user request may be submitted to generate a report. For example, a report may relate to historical transaction data such as funds transfers, purchases, account credits, payments, or the like. The report may further incorporate policy, rules and/or knowledge based documents along with user specific data. The system may be configured to search a separate database to determine whether the user request has previously been requested and to retrieve previously generated results if the user request has previously been submitted by a user. The system may further incorporate one or more machine learning techniques (e.g., incorporating a large language model) to generate the report. For example, the machine learning model may incorporate rules, policy, and knowledge based information, which extracting user specific data (e.g., historical data transactions) to generate the report. The report may include graphs and other visuals that implement the user’s historical data transactions. The system may further receive feedback from the user and update the user response based on the obtained feedback.

As used herein, a “machine-learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

The execution of the machine-learning model may include deployment of one or more machine-learning techniques, such as linear regression, logistic regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

While several of the examples herein involve certain types of machine-learning and artificial intelligence, it should be understood that techniques according to this disclosure may be adapted to any suitable type of machine-learning and artificial intelligence. It should also be understood that the examples above are illustrative only. The techniques and technologies of this disclosure may be adapted to any suitable activity.

While financial applications and various aspects relating to finance (e.g., account management and automation) are described in the present aspects as illustrative examples, the present aspects are not limited to such examples. For example, the present aspects can be implemented for other types of fields, such as in any scenario related to optimizing data or predicting outcomes.

As used herein, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an embodiment of the disclosure, the module may be implemented in a form of an application-specific integrated circuit (ASIC), a field-programmable gate array (FPGA), or a combination of hardware and software instructions.

As used herein, the term “knowledge base” or “KB” may refer to a repository or storage system configured to store policies, rules, articles, documentation, and other information that may be retrieved and used for generating reports or responses. The knowledge base may include structured and unstructured data, and may be organized to facilitate efficient searching and retrieval operations.

As used herein, the term “session” may refer to a user interaction history that captures previous requests, queries, and responses associated with a particular user or user account. A session may be used to maintain context across multiple interactions, enabling the system to provide more relevant and contextually appropriate responses based on prior exchanges.

As used herein, the term “vector search” may refer to a search technique that converts queries and documents into numerical vector representations (embeddings) and identifies relevant documents based on similarity measures between vectors. Vector search may enable semantic matching that captures meaning beyond exact keyword matches.

As used herein, the term “lexical search” may refer to a search technique that matches queries to documents based on the presence and frequency of specific words or terms. Lexical search may be combined with vector search in a hybrid search approach to improve retrieval accuracy.

As used herein, the term “embedding” may refer to a vector representation of text, documents, or other data in a multi-dimensional space. Embeddings may be generated by machine learning models and may capture semantic relationships between different pieces of content, enabling similarity-based retrieval operations.

As used herein, the term “FAQ” or “frequently asked question” may refer to a question or request that has been submitted to the system multiple times or with sufficient frequency to warrant caching of the associated response. FAQs may be stored in a cache or database to enable rapid retrieval without requiring full processing through the machine learning model.

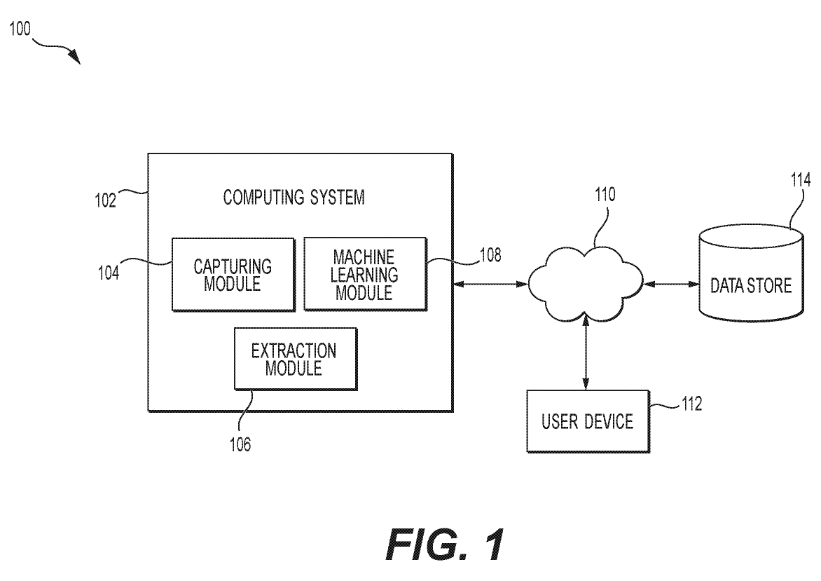

A user of a system may have a history of performing financial transactions. These financial transactions may be recorded as historical transaction data over a period of time. The period of time from which historical transaction data is captured may be the life of the account, and the data may be capture though a computing system (e.g., such as computing system 102 depicted in FIG. 1) over the life of the account for processing. It may be valuable for a document or report to capture financial transactions. It may be further valuable for the financial transaction data to be further analyzed based on a set of policies, rules, and/or knowledge based documents.

One or more embodiments of the system described herein, may receive an input including a request from a user. The request may be a question or a request for documentation related to a user’s financial transactions. The one or more systems may implement a machine-learning model, wherein the machine-learning model is configured to incorporate a user’s financial transaction data along with polices, rules, and/or knowledge based documents to generate an output to the user. The output may include a report, wherein the report incorporates policies or rules to analyze a particular user’s financial transaction data to generate the report.

For example, the machine-learning model may be used for managing accounts, such as extracting data, generating queries, forecasting account balances, predicting and executing best practices for liquidity, generating reports using natural language processing, and the like. An artificial intelligence model, or the machine-learning model, may generate scenarios for liquidity optimization based on a set of rules, and automatically select the best scenario. Further, sentiment analysis and forecasting may be used to predict closing balances, cash flows, and the like.

Using the disclosed techniques, users (e.g., account owners, administrators, or managers) of the system described herein may generate reports that may optimize returns, minimize costs, and mitigate risks associated with both present and future cash positions. The decision-making process, and the execution of these decisions, to achieve these results may be automated by using the techniques described herein.

FIG. 1 depicts an exemplary environment 100 that may be utilized with techniques presented herein. One or more user device(s) 112 may communicate across an electronic network 110. The one or more user device(s) 112 may be associated with a user, e.g., a user that is managing an account, an administrator of one or more components of environment 100, or the like. As will be discussed in further detail below, one or more computing system(s) 102 may communicate with one or more of the other components of the environment 100 across electronic network 110.

The user device(s) 112 may be configured to enable a user to access and/or interact with other systems in the environment 100. For example, the user device(s) 112 may each be a computer system such as, for example, a desktop computer, a mobile device, a tablet, etc. In some embodiments, the user device(s) 112 may include one or more electronic application(s), e.g., a program, plugin, browser extension, etc., installed on a memory of the user device(s) 112. In some embodiments, the electronic application(s) may be associated with one or more of the other components in the environment 100. For example, the electronic application(s) may include one or more of system control software, system monitoring software, software development tools, etc.

In various embodiments, the environment 100 may include a data store 114 (e.g., database). The data store 114 may include a server system and/or a data storage system such as computer-readable memory such as a hard drive, flash drive, disk, etc. In some embodiments, the data store 114 includes and/or interacts with an application programming interface for exchanging data to other systems, e.g., one or more of the other components of the environment. The data store 114 may include and/or act as a repository or source for storing historical transaction data, item level features, input and/or output of the machine-learning or artificial intelligence models, generated reports, and the like (e.g., a user of user device 112 or any of the other components of environment 100). In some embodiments, the data store 114 may be implemented using various storage technologies including relational databases, NoSQL databases (e.g., DynamoDB, CosmosDB), vector databases, blob storage, or combinations thereof. In various aspects, different types of data may be stored in different storage systems optimized for the particular data type and access patterns. For example, the data store 114 may include a cache for storing frequently asked questions (FAQs) and their corresponding answers to enable rapid retrieval without requiring full processing through the machine learning model.

In some embodiments, the components of the environment 100 are associated with a common entity, e.g., a corporate or financial institution, a service provider, an account provider, or the like. For example, in some embodiments, computing system 102 and data store 114 may be associated with a common entity. In some embodiments, one or more of the components of the environment is associated with a different entity than another. For example, computing system 102 may be associated with a first entity (e.g., a service provider) while data store 114 may be associated with a second entity (e.g., a storage entity providing storage services to the first entity). The systems and devices of the environment 100 may communicate in any arrangement. As will be discussed herein, systems and/or devices of the environment 100 may communicate in order to one or more of generate, train, or use a machine-learning and/or artificial intelligence model to manage accounts, among other activities.

As discussed in further detail below, the computing system(s) 102 may one or more of (i) generate, store, train, or use a machine-learning model configured to analyze one or more user’s financial transactions based on a set of policies or rules. The computing system(s) 102 may include a machine-learning model and/or instructions associated with the machine-learning model, e.g., instructions for generating a machine-learning model, training the machine-learning model, using the machine-learning model etc. The computing system(s) 102 may include instructions for retrieving data, adjusting data, e.g., based on the output of the machine-learning model, and/or operating a display of the user device(s) 112 to output the results, e.g., as adjusted based on the machine-learning model. The computing system(s) 102 may include training data, e.g., historical transaction data and/or item level features, and may include ground truth, e.g., (i) training historical transaction data and (ii) training item level feature data to generate the output.

As depicted in FIG. 1, computing system(s) 102 may include capturing module 104. In various embodiments, capturing module 104 is configured to capture historical transaction data of a client account. The historical transaction data may be received by computing system(s) 102 over network 110. The capturing module 104 may further be configured to receive one or more rules, policies, or knowledge based articles related to historical transaction data. In some embodiments, the capturing module 104 may receive data in various formats including structured data (e.g., database records, spreadsheets) and unstructured data (e.g., text documents, policy PDFs). The capturing module 104 may be configured to normalize and preprocess received data for further processing by other modules of the computing system(s) 102. In various aspects, the capturing module 104 may perform input validation including lexical/syntactic validation to verify that requests conform to expected API formats and syntax.

Computing system(s) 102 may also include extraction module 106. In various embodiments, extraction module 106 may be configured to extract item level features from the historical transaction data. The item level features may be stored in data store 114 and retrieved by components of computing system 102 for use. In some embodiments, the extraction module 106 may extract text from policy documents using document intelligence techniques. The extraction module 106 may also be configured to extract images from documents for processing by computer vision models. In various aspects, the extraction module 106 may generate embeddings from extracted text, wherein the embeddings are vector representations that capture semantic meaning of the text content. These embeddings may be stored in a vector database for subsequent search operations.

As depicted in FIG. 1, computing system(s) 102 may also include machine-learning module 108. In some embodiments, a system or device other than the computing system(s) 102 is used to generate and/or train the machine-learning model. For example, such a system may include instructions for generating the machine-learning model, the training data and ground truth, and/or instructions for training the machine-learning model. A resulting trained-machine-learning model may then be provided to the computing system(s) 102.

Generally, a machine-learning model includes a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based on Gaussian noise, a pre-trained model, or the like. The output may be compared with the ground truth to determine an error, which may then be back-propagated through the model to adjust the values of the variable.

Training may be conducted in any suitable manner, e.g., in batches, and may include any suitable training methodology, e.g., stochastic or non-stochastic gradient descent, gradient boosting, random forest, etc. In some embodiments, a portion of the training data may be withheld during training and/or used to validate the trained machine-learning model, e.g., compare the output of the trained model with the ground truth for that portion of the training data to evaluate an accuracy of the trained model. The training of the machine-learning model may be configured to cause the machine-learning model to learn associations and/or identify patterns in item level features and/or historical transaction data such that the trained machine-learning model is configured to generate output results.

In various embodiments, the variables of a machine-learning model may be interrelated in any suitable arrangement in order to generate the output. For example, in some embodiments, the machine-learning model may include data processing architecture that is configured to identify, isolate, and/or extract features in one or more of historical transaction data and item level features. For example, the machine-learning model may include one or more convolutional neural network (“CNN”) configured to identify patterns in the item level features, and may include further architecture, e.g., a connected layer, neural network, etc., configured to determine a relationship between the identified patterns in order to output a prediction, action to be taken, or to generate a report.

In some embodiments, the machine-learning model of the computing system 102 may include a Recurrent Neural Network (“RNN”). Generally, RNNs are a class of feed-forward neural networks that may be well adapted to processing a sequence of inputs. In some embodiments, the machine-learning model may include a Long Short Term Memory (“LSTM”) model and/or Sequence to Sequence (“Seq2Seq”) model. An LSTM model may be configured to generate an output from a sample that takes at least some previous samples and/or outputs into account. A Seq2Seq model may be configured to, for example, receive a sequence of item level features and output a prediction, action to be taken, a projected balance, a report, or the like.

As depicted in FIG. 1, environment 100 may also include electronic network 110. In various embodiments, the electronic network 110 may be a wide area network (“WAN”), a local area network (“LAN”), personal area network (“PAN”), or the like. In some embodiments, electronic network 110 includes the Internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

Although depicted as separate components in FIG. 1, it should be understood that a component or portion of a component in the environment 100 may, in some embodiments, be integrated with or incorporated into one or more other components. In another example, the computing system 102 may be integrated in a data storage system. The data storage system may be configured to communicate and/or receive/send data across electronic network 110 to other components of environment 100. In some embodiments, operations or aspects of one or more of the components discussed above may be distributed amongst one or more other components. Any suitable arrangement and/or integration of the various systems and devices of the environment 100 may be used.

Further aspects of the machine-learning model and/or how it may be utilized to process historical account data and/or item level features are discussed in further detail in the methods below. In the following methods, various acts may be described as performed or executed by a component from FIG. 1, such as the computing system 102, the user device 112, or components thereof. However, it should be understood that in various embodiments, various components of the environment 100 discussed above may execute instructions or perform acts including the acts discussed below. An act performed by a device may be considered to be performed by a processor, actuator, or the like associated with that device. Further, it should be understood that in various embodiments, various steps may be added, omitted, and/or rearranged in any suitable manner.

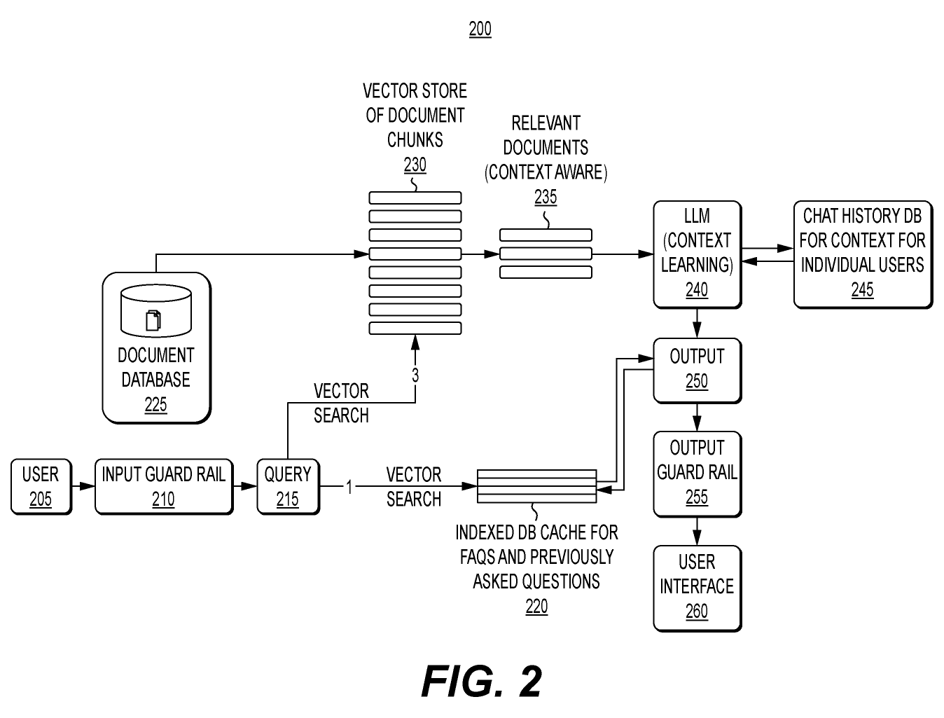

FIG. 2 depicts an exemplary environment 200 implementing a machine-learning model to generate a user response, according to one or more embodiments. The environment 200 may be implemented by aspects or modules of the environment 100 from FIG. 1. The environment 200 may include a user device 205, an input guard rail module 210, a query 215, an indexed database cache 220, a document database 225, a vector store of document chunks 230, a set of relevant documents 235, one or more machine-learning systems 240 (e.g., a large language model), a chat history database 245 (e.g., a chat history database for individual users), an output 250, a guard rail model 255, and an user interface 260.

The user device 205 may include one or more processors in a computing device to provide a user interface to a user where the user may input a request to generate a report or response to a user response (e.g., a user response related to financial terms and/or transactions). In some embodiments, the user device 205 may be a desktop computer, laptop computer, tablet, smartphone, or other computing device capable of network communication. The user device 205 may execute a web browser, mobile application, or dedicated client application to interact with the system. The input guard rail module 210 may include a set of instructions for one or more processors in a computing device to filter the request input by the user. The input guard rail module 210 may include one or more algorithms configured to validate the lexical/syntactic language of a query 215 and to validate the content safety of a query 215 (e.g., to remove harmful content). In some embodiments, the lexical/syntactic validation may verify that the request conforms to expected API formats and syntax, which may help prevent malicious requests or system overload from improperly formatted inputs. The content safety validation may analyze the request to detect harmful content including text related to hate, self-harm, sex, and/or violence. In various aspects, the input guard rail module 210 may also verify that the request is relevant to the domain of the system (e.g., treasury management) and may reject requests that are outside the scope of the system’s intended functionality.

The query 215 may include a received response by the user device 205 that may be a user request (e.g., a request to create a report) as described in greater detail below. The query 215 may be filtered by the input guard rail module 210. In some examples, the query 215 may be altered language of the received response, wherein the query 215 may allow for the system described herein to search a database for related content. The indexed database cache 220 may include a set of frequently asked questions (FAQs) along with corresponding results. In some embodiments, the indexed database cache 220 may be implemented using a database such as DynamoDB, CosmosDB, or other suitable database technology. The indexed database cache 220 may store FAQ data including a FAQ identifier, the query text, query embeddings, the answer, citations, an active status indicator, a usage count, a negative usage count, creation timestamp, last used timestamp, and last active timestamp. This data structure enables tracking of FAQ usage patterns and maintaining current information. The query 215 may access the indexed database cache 220 and may perform a vector search to determine whether the query matches a previously asked question. The environment 200 may also access a vector store of document chunks 230. The vector store of document chunks 230 may be accessed from a document database 225 that stores polices, rules, and/or knowledge based articles. The vector store of document chunks 230 may be extracted text from the policies, rules, and/or knowledge based articles. In some embodiments, documents stored in the document database 225 may be processed through a chunking operation that divides the documents into smaller segments suitable for embedding generation and vector search. The chunks may be converted to vector embeddings and stored in the vector store of document chunks 230 for efficient similarity-based retrieval. The system described herein, may be based upon the user request, identify a set of relevant documents 235 based on the vector store of document chunks 230. These set of relevant documents 235 may assist in providing a user response.

The environment 200 may further include one or more machine-learning systems 240. For example, the one or more machine-learning systems 240 may be a large language model (LLM). The LLM may be trained to utilize a received user response along with the retrieve the set of relevant documents 235 to generate a user response. For example, the generated user response may be a report. The LLM may further access previous analysis (i.e.., the chat history database 245) and interactions with user to generate a user response. The chat history database 245 may store session history for individual users, enabling the system to maintain context across multiple interactions. In some embodiments, the chat history database 245 may be implemented using cache memory or a database system. The session history may include previous prompts submitted by the user, previous responses generated by the system, and metadata associated with the interactions. By incorporating session history, the machine-learning systems 240 may generate responses that are contextually relevant to the ongoing conversation. This report may then be output 250 to a user. The generated output 250 may further be passed through a guard rail model 255 containing a guard rail algorithm or processor. This guard rail model 255 may further review the response and filter out unnecessary or unrelated aspects of the response. In some embodiments, the guard rail model 255 may implement content-safety policies to ensure that generated responses do not contain harmful, inappropriate, or irrelevant content. The guard rail model 255 may be implemented using open source software or proprietary content filtering systems. The user interface 260 may be the user interface of the user device 205, and may include one or more processors in a computing device to display the generated report to the user.

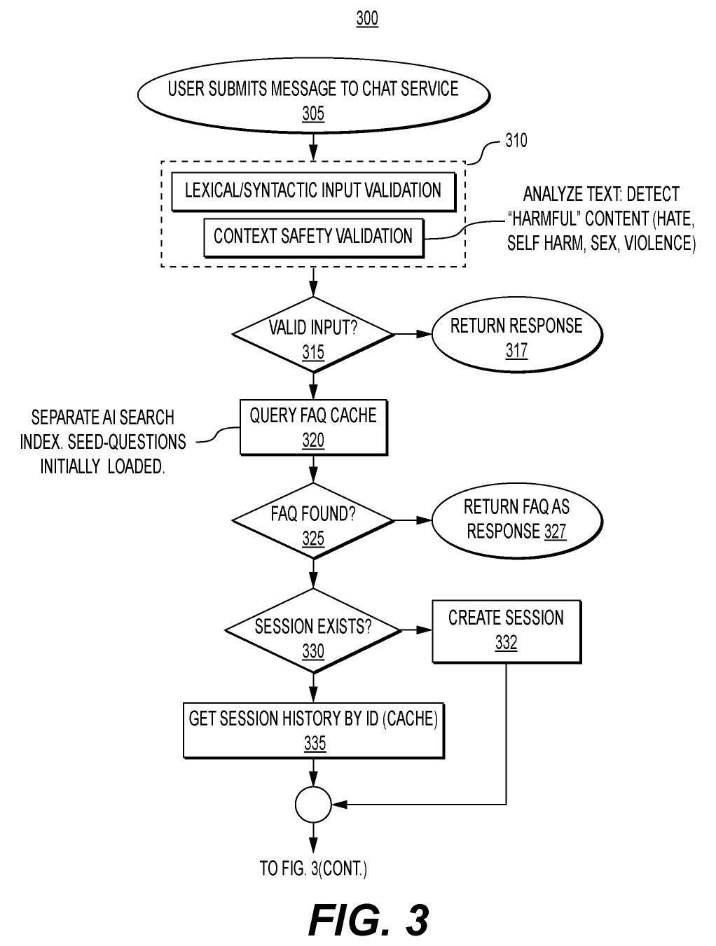

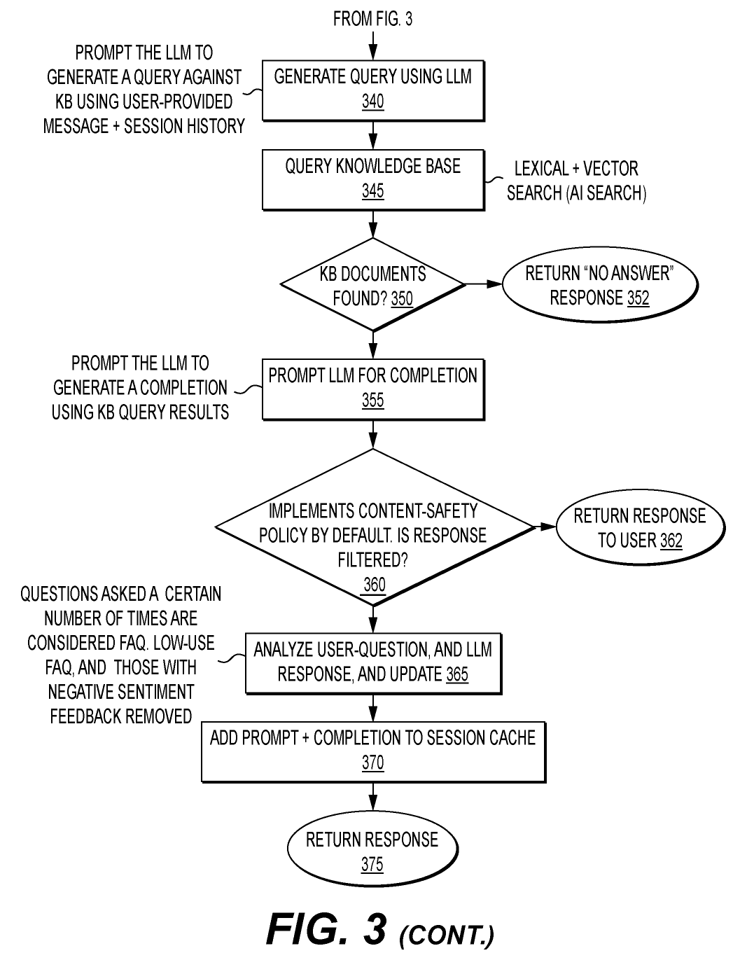

FIG. 3 depicts a flow diagram 300 for implementing a machine learning model to generate a user response, according to one or more embodiments. One or more steps of the flow diagram 300 may be implemented by the environment 100 of FIG. 1 and/or environment 200 of FIG. 2. Further, steps from flow diagram 300 may performed in a computing device that may include one or more processors and a machine-learning model configured to perform a set of instructions to perform steps 305-375.

At step 305, a user may submit a request to a system. For example, the user may send a request to generate a report, wherein the report incorporates the user’s financial transaction data along with analysis of the financial transaction data. The financial transaction analysis may be performed based on or more rules, policies, or knowledge based articles stored in the system described herein.

At step 310, the system described herein may analyze the received request for lexical/syntactic input validation and filter for content safety validation to detect harmful content. Harmful content may include text related to hate, self-harm, sex, and/or violence, but embodiments are not limited thereto. The system may apply one or more algorithms to verify lexical/synaptic validation of the response. In other words, the algorithm may verify that a question is being asked and that the terms of the request are valid. For example, a request with incorrect spellings or non-logical phrases may be detected. In some embodiments, everything may be received in the form of API requests, and the system may validate whether the API is a valid API in the expected format. The lexical/syntactic validation may help prevent hackers from calling APIs in improper syntax to put load on the system. The system described herein may further incorporate one or more algorithms designed to search for particular words or phrases considered harmful, and to determine whether the user request from step 305 includes any of this language. In various aspects, the system may be configured with a system prompt to ensure that only requests related to the system’s domain (e.g., treasury management) are processed. Requests outside the domain scope (e.g., “who is the President”) may not receive a response, as the system may be configured to only respond to domain-relevant queries.

At step 315, the request may be validated and it may be determined whether the request is a valid input. A valid request may be defined as a request that includes valid lexical input that further did not include harmful language. At step 317, upon determining that a user request from step 305 is invalid, the system may output to a user a message that an invalid request was received and no further operations may be performed.

In case of a determination that the request is a valid request, step 320 may be performed. At step 320, the system may determine whether a similar request has previously been received by the system. For example, the user request from step 305 may be extracted and input into a separate database (e.g., indexed database cache 220) to determine whether the user request has previously been input to the system. For example, a search of similar requests previously made (i.e., an AI search) may be performed by an algorithm or machine learning model using the separate database, which may include a vector database with embeddings stored therein. The user request may be converted to a vector prior to the search. The system described herein may have a database that stores frequently asked user requests (e.g., FAQs) along with the respective outputs.

In some embodiments, the FAQ search may generate a score comparing the query to a closest FAQ saved to the FAQ database. The score may range from 0 to 1, where 1 represents a perfect match (e.g., verbatim the same user request) and 0 means the search has no overlap with any FAQs. Based on the score, the system may determine whether the retrieved user request matches to a FAQ. For example, if the generated score is greater than a threshold value (e.g., 0.80), the FAQ and respective answer associated with the FAQ may be retrieved from FAQ storage.

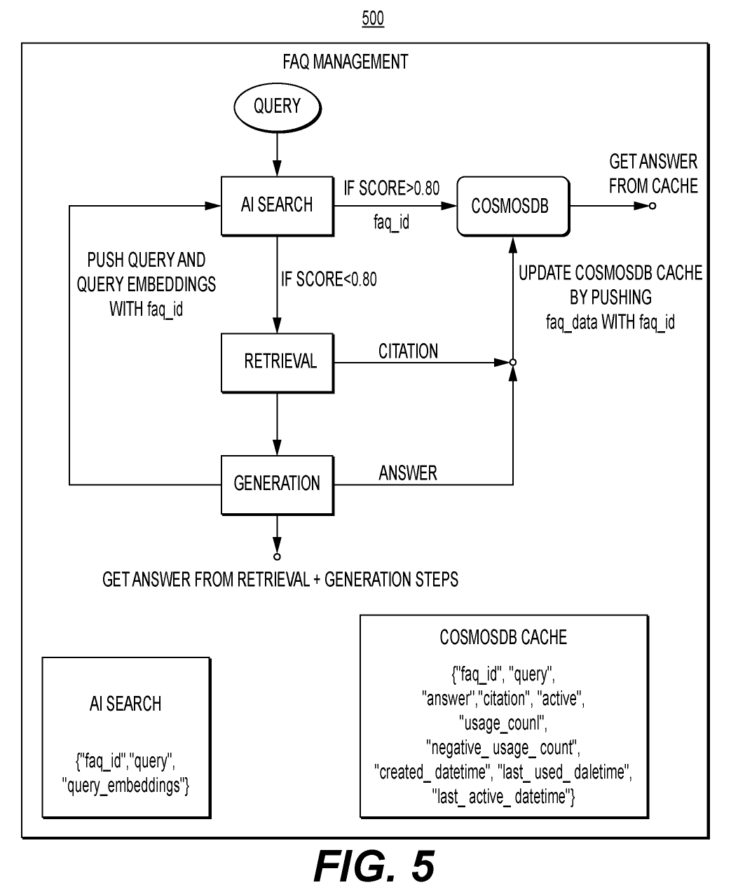

Step 320 may be described in greater detail in FIG. 5 below. At step 325, if a user response is determined to be a frequently asked question (e.g., a previously submitted user response), the previous solution (or generated client report or response) may be retrieved. At step 327, the previous response may be submitted to a user. In some examples, the previous response may provide general information along with specific user information. In these scenarios, specific data relating to the user from step 305 may be retrieved and output along with the general information. If a user response is considered to be a frequently asked question, further operations are bypassed and a previously generated client report may be retrieved and transmitted to the user as a client report. For example, the request or a similar request may be stored as a FAQ in a memory storage (e.g., cache memory) and a previously generated client report may have been created in response to the previous request stored as a FAQ. In such a case, the previously generated report may be retrieved and transmitted to the user as the client report. Upon determining that the request has not been previously received, at step 330, the system may determine whether the user has an associated session assigned. For example, an associated session may be a set of previous request or questions submitted by the user to the system. An associated session may refer to saved history of previous request sent by the user to the system described herein. Step 330 may be performed by comparing a user account or associated identification number to a database of stored previous user accounts/numbers. At step 332, if no associated session is determined, the system may create a new session linking the user to the newly created session. At step 335, if an associated session if found, the previous session data may be extracted from storage (e.g., cache memory) for further use by the system. After step 332 or 335, the user from step 305 may have an assigned session to save response to.

At step 340, a query may be generated using a machine learning system such as a Large Language Model (LLM). The query may be a rephrased or modified version of the user request from step 305. The query may be in a more effective format for the system described herein to search a database for relevant policies, rules, or knowledge based articles. For example, step 340 may include generating a prompt to the LLM to generate a query based on the user request and the session history (e.g., in case of an existing session). In some embodiments, the LLM may be prompted to generate a query against the knowledge base (KB) using the user-provided message and session history. The LLM may output a query as a response to this prompt. The determined query may for example more effectively sort through a database of saved rules, policies, and knowledge based articles. The generated query may be saved as a query data object. In some embodiments, a machine learning model (e.g., AI) may perform a hybrid search (e.g., lexical search and/or vector search) and generate a query based on confluence data in a knowledge base (KB). In some embodiments, the knowledge base may be stored as embeddings in a vector database. In some embodiments, a batch process may be made periodically (e.g., every 15 days) where a knowledge base may be updated with new policies, rules, or articles. The batch process may include extracting text from newly added documents, generating embeddings for the extracted text, and storing the embeddings in the vector database for subsequent search operations.

At step 345, the generated query from step 340 may be utilized to search one or more database for any relevant rules, polices, or KB articles. The search may be a lexical and a vector search. For example, the generated query from step 340 may be plugged in as a search vector to one or more databases to pull relevant rules, polices, or KB articles. All relevant rules, policies, or KB articles may be extracted for further use. At step 345, user historical transaction data may be retrieved from storage. In some embodiments, a hybrid search may be made, the hybrid search may include a combination of a lexical search and a vector search. In some embodiments, a search may be an embedding-based search.

At step 350, the extracted results from step 345 may be analyzed. If no relevant rules, policies, or KB articles were determined, then at step 352 a response may be generated to the user indicating that no answer was determined. The response may further indicate that a client report could not be generated. The user may further receive an option to insert an updated or new request for the system.

At step 355, an LLM may be prompted to determine a response to the user request from step 305 based on retrieved information from step 345. The LLM may for example extract relevant historical transaction data that corresponds to the extracted rules, policies, and KB articles. The LLM may then proceed to prepare one or more outputs such as a report, incorporating user specific data, that may be further analyzed based on the extracted rules and policies. For example, charts and graphs of user data may be created. Further, algorithms may be applied and displayed for output. In some embodiments, the generated response may include citations and related links to the source documents. The citations may enable the user to access the original policy documents, rules, or knowledge base articles from which the response was derived. As will be discussed in greater detail below, the system described herein may request user input in order to structure the response to the user. A user response may be created in the format of a report. The report may include one or more graphs, tables, applied mathematic equations, and related textual context.

At step 360, an additional software may be applied to the generated response from step 355 to implement content-safety policy to filter any irrelevant and inappropriate context from the generated response. For example, the software may be implemented by an open source software (e.g., Azure OpenAI), but embodiments are not limited thereto. In case the generated response includes content that does not meets a criteria (e.g., policies, harmful content) and/or the generated response includes any irrelevant or inappropriate context, at step 362, a response may be generated to the user indicating that no answer was determined.

In case that, at step 360, it is determined that the generated response meets the criteria, at step 365, the system may implement a secondary process to analyze the user prompt from step 305 to determine whether the question and result should be saved as a frequently asked question. All previous user requests received by the system may be saved in a database. In some embodiments, the user response from step 305 or generated query from step 340 may be input to the database. A search may then be performed to determine whether the user request or a similar user request has been previously asked. A count of the number of times the particular search has been made may then be recorded, where the count is set to zero if the search has not previously been made. If a similar or the same search has been searched before, the assigned count to that search may increase by one. When a particular count for a question increases a threshold value (e.g., after a fifth search), the particular search and corresponding answer may be recorded and considered as a FAQ question. This may then be transferred to a separate database (e.g., the database accessed at step 320). These more frequently asked questions may then be more easily accessible to a user.

In some embodiments, the FAQ management process may also consider feedback received from users. Questions that receive negative sentiment feedback may be flagged for review or removed from the FAQ cache. Low-use FAQs that have not been accessed within a specified time period may also be removed or deactivated to maintain the relevance and accuracy of the FAQ database. The FAQ data structure may include fields for tracking usage count, negative usage count, creation timestamp, last used timestamp, and last active timestamp to support these management operations.

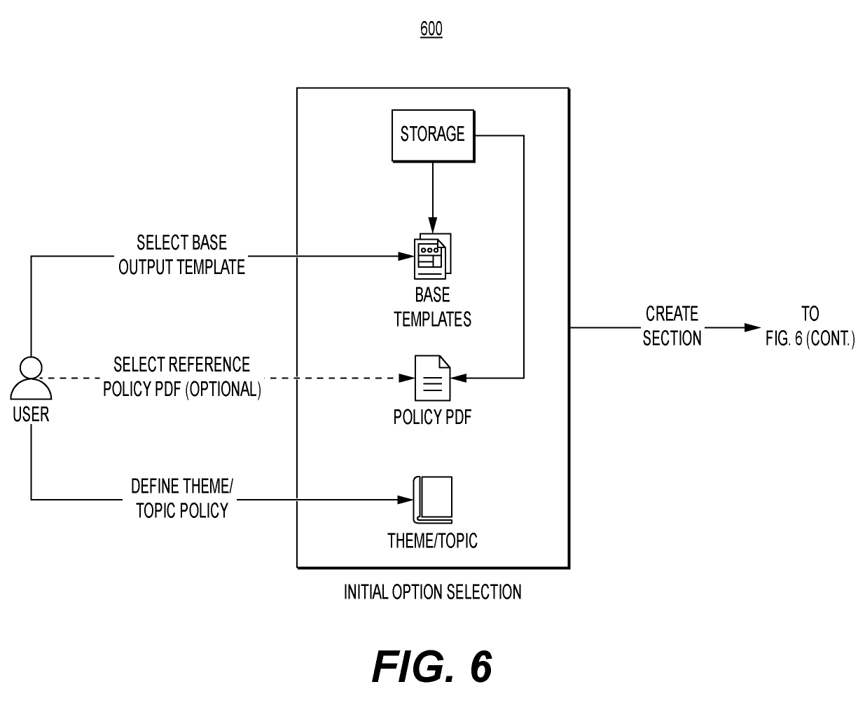

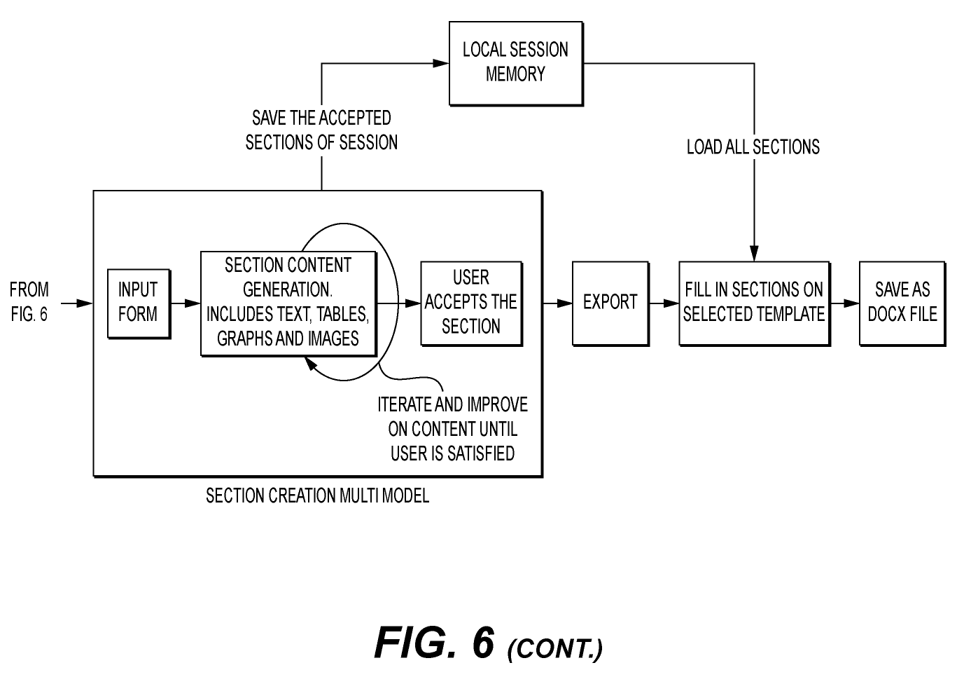

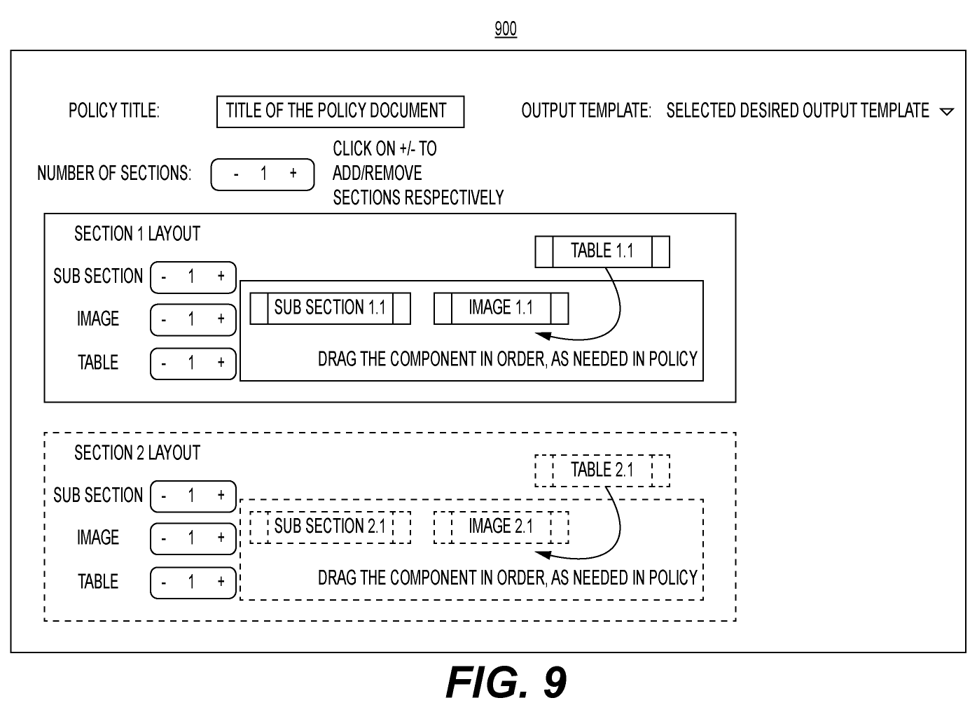

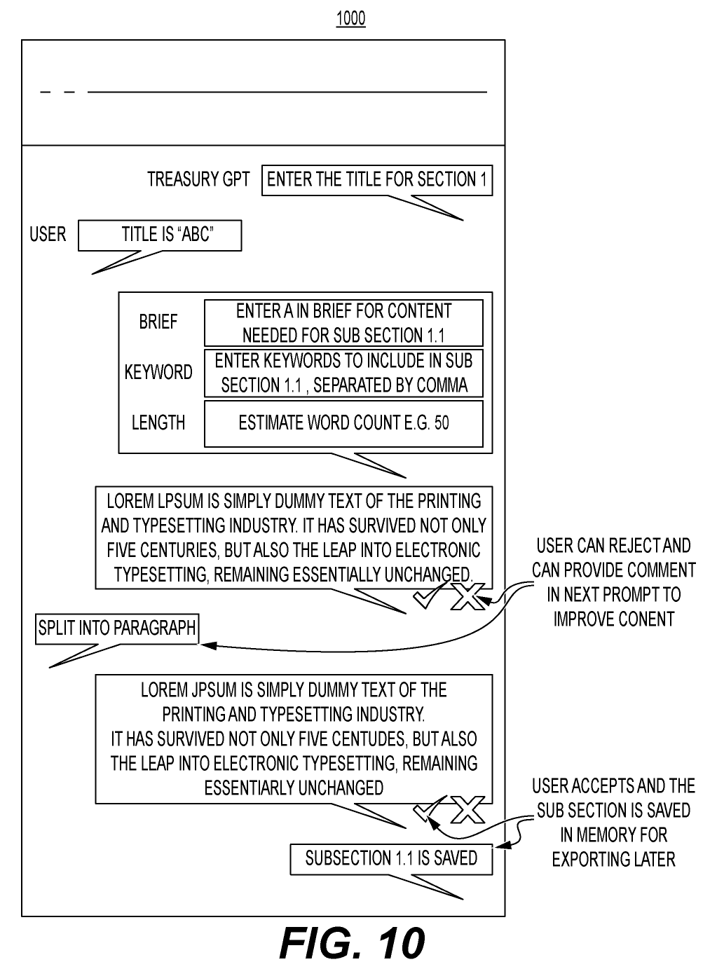

At step 370, the session may be updated to record the determined response and saved for future reference. This may be saved in a session specific cache that may be accessed when the user requests a separate response. A prompt and a completion to the session history (e.g., cache memory) may be added and/or performed. In operation 375, the generated report may be transmitted to the user. In some embodiments, the generated report may be transmitted to the user using a user interface (e.g., a display). In various aspects, the system may include a feedback module configured to receive feedback from the user. Feedback may be given on every question and response, as well as overall feedback at a session level. After the session is over, similar to other generative AI engines, the user may provide overall feedback on the session. The feedback may be used to improve the system’s responses and update the FAQ cache.In an example, the user from step 305 may optionally provide format requests for the user response. This process may for example be displayed in the flowchart of FIG. 6. This may allow a user to select a report format (as shown in FIG. 9). Further, the user may, upon receiving a report at step 355, provide feedback to the format as displayed in FIG. 10 – 12. The system may be configured to utilize the LLM to update the user response as requested. These updates may be saved to the session history.

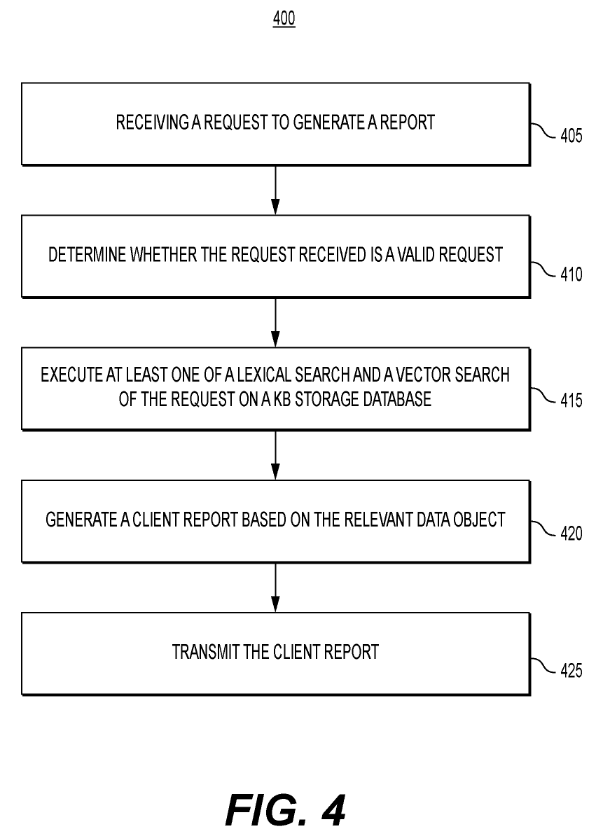

FIG. 4 depicts a flow diagram 400 of an exemplary method for report generation, according to one or more embodiments. One or more steps of the flow diagram 400 may be implemented by the environment 100 of FIG. 1 and/or environment 200 of FIG. 2. Further, steps from flow diagram 400 may performed a computing device may include one or more processors and a machine learning model configured to perform a set of instructions to perform steps 405-425.

At step 405, a request to generate a report may be received from a user. At step 410, a determination of whether the request received is a valid request may be made by one or more processors in a computing device. A determination of whether the request received is a valid request may include determining whether the request includes harmful content. For example, harmful content may include text related to sex, hate, self-harm, and/or violence, but embodiments are not limited thereto. A determination of whether a similar request has been previously received by the one or more processors, based on a request history, may be made, and upon determining that the request has been previously been received, an execution of at least one of the lexical search and a vector search (e.g., step 415) may be bypassed, and a previously generated client report may be retrieved and transmitted as a client report. A determination of whether the user has made a previous request to generate a report may be made. Upon determining that a previous request to make a report was made by the user and that a previous report was generated, a session history from storage may be retrieved and may be provided to the machine learning model, and the machine learning model may be configured to incorporate the session history retrieved when generating the requested report. Upon a determination that the user has not made a previous request to generate a client report, a new session for the user may be created.

At step 415, execution of at least one of a lexical search and a vector search of the request on a knowledge based storage database to determine a relevant data object may be made by one or more processors. A machine learning model may be configured to generate a search query based on the request and any past request from the user, wherein the machine learning model may be configured to use the search query to perform the lexical search and the vector search. If the lexical search and vector search of the request based storage database returns no result, a response indicating that no answer can be found may be transmitted to the user interface and no client report may be transmitted.

At step 420, generation of a client report based on the relevant data object may be made by a machine learning model. In some embodiments, the generated client report may include citations and related links to the source documents from which the report was derived, enabling the user to access the original policy documents, rules, or knowledge base articles. At step 425, the generated client report may be transmitted to a user interface by the one or more processors. Additionally, although not depicted in the flow diagram 400, the method for report generation may include identifying a count of how many times the request or a similar request has been made to the one or more processors and, if the count exceeds a threshold value, the method for report generation may include storing the request with the associated client report to the knowledge based database. Additionally, although not depicted in the flow diagram 400, the method for report generation may include requesting a feedback response from the user about the client report after transmitting the client report.

FIG. 5 depicts a flow diagram 500 for a FAQ management system, according to one or more embodiments. The flow diagram 500 may correspond to step 320, steps 345, and 355 of the flow diagram 300 of FIG. 3.

For example, based on a query may be generated based on a user request as described above. In some embodiments, the system may load initial seed questions into the FAQ database (e.g., DynamoDB). The seed questions may be pre-populated with common queries and their corresponding answers to enable rapid responses for frequently encountered requests. The query may be plugged into a search index of FAQ’s and a search (i.e., an AI search) may be performed by an algorithm or machine learning model. The search may generate a score comparing the query to a closest FAQ saved to the FAQ database. The score may be from 0 to 1, where 1 is a perfect match (e.g., verbatim the same user request) and 0 means the search has no overlap with any FAQs. Based on the score, the system may determine whether the retrieved user request matches to a FAQ.

For example, if the generated score is greater than a threshold value (e.g., 0.8), the FAQ and respective answer associated with the FAQ may be retrieved from FAQ storage. For example, when a query is received, a search may be performed of the received query (or a similar query) in a database (e.g., a cosmosDB) including queries (or questions) frequently made (FAQs). If the query (or a similar query) is found in the database (e.g., the query matches with a FAQ stored in the database), an answer to the query based on the answer previously provided to the query found in the database may be provided to the client. This may for example be described at step 320.

In some embodiments, if the received query (or a similar query) is not found in the database (e.g., the score is less than the threshold value of 0.80), a retrieval and generation process may be performed. In the retrieval process, a search of the query may be made on a vector database that includes a batch having embeddings stored therein. The search may retrieve the top results (e.g., the top three results), rank the top results, and provide the top results to a generation engine to generate an answer to the query

In some embodiments, a machine learning model (e.g., AI) may perform a hybrid search (e.g., lexical search and/or vector search) of the received query on a vector database, and upon retrieving results of the search, the machine learning model may retrieve relevant content and generate an answer based on the retrieved results. The answer and citation may then be used to update the FAQ cache by storing the FAQ data with the associated FAQ identifier. The FAQ data structure may include fields such as “faq_id,” “query,” “query_embeddings,” “answer,” “citation,” “active status,” “usage_count”, “negative_usage_count,” “created_datetime,” “last_used_datetime,” and “last_active_datetime.” This structure enables tracking of FAQ usage patterns and maintaining current information.

As described above, the answer and question may be saved as a FAQ if the question has been asked a set number of times. In some embodiments, queries that are made frequently (e.g., FAQs) and answers to such queries may be stored in a database (e.g., CosmosDB), such that if the query received is the same (or similar) to queries stored in the database, answers to the queries stored in the database may be retrieved and be directly provided to the user without requiring full processing through the machine learning model.

In some embodiments, a batch process may run periodically to update the frequently asked questions in the FAQ cache. The questions which are frequently asked at one time may be different than the questions which will be frequently asked at a later time. The system may check the feedback received from users and the questions being asked to keep updating the cache of frequently asked questions. This dynamic updating ensures that the FAQ cache remains relevant and accurate over time.

FIG. 6 depicts a flow diagram for policy document generation, according to one or more embodiments. Policy generation 600 may include a process where a user may select base output templates, may optionally select reference policy, and may define a theme and/or topic policy. In some embodiments, users may provide high-level ideas or themes (e.g., “portfolio recommendation” or “treasury portfolio recommendation”) and the system may generate policy documents based on those inputs. The system may take from general policy documents and create new documents based on user-defined themes. These selections may then be transmitted to an initial option selection including a storage, base templates, policy documents, and theme/topics. In some embodiments, the storage may be an Azure Blob Storage, but embodiments are not limited thereto. Other storage systems such as Amazon S3, Google Cloud Storage, or on-premises storage systems may also be used.

The policy generation 600 may then create a section based on the initial option selections. The section created may be a section creation via open AI multi-model. In some embodiments, the open AI may be an Azure Open AI, but embodiments are not limited thereto. Other large language model systems or multi-modal AI systems may also be used. In the section created, an input form may be transmitted to a section content generation, including text, tables, graphs, and images, which may be then transmitted to a user to accept the section created.

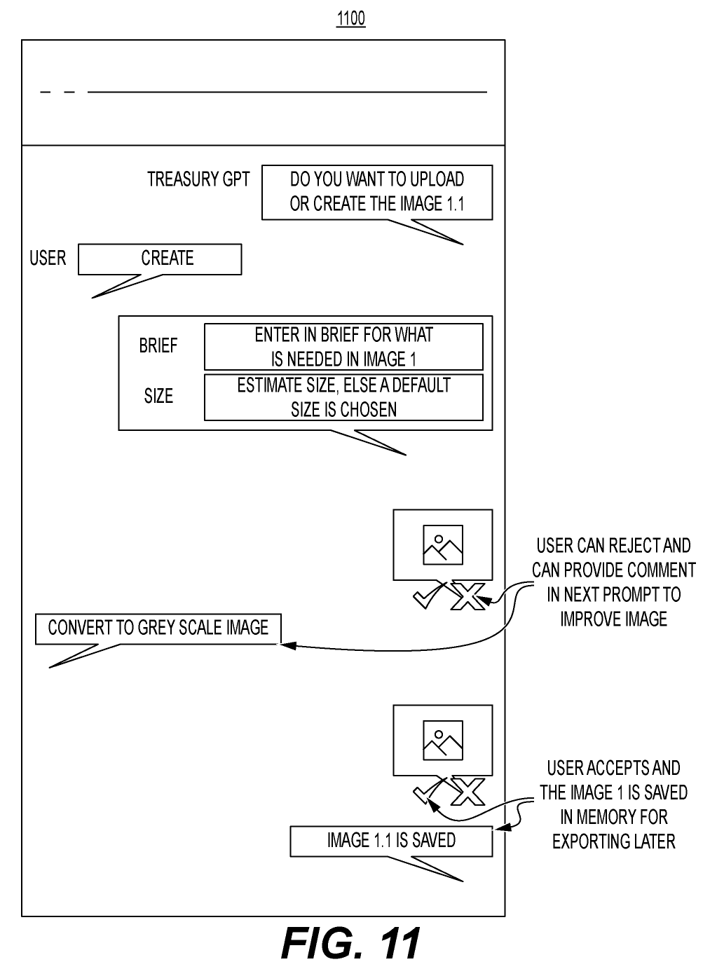

The section content generation may also be iterated and improved on content until the user is satisfied. For example, as shown in FIG. 10 and 11, a user may review and provide feedback to selected templates, while the system updates the outputs based on the user selections. The user may reject generated content and provide comments in a subsequent prompt to improve the content. The system may use the LLM to regenerate content based on the user feedback. This iterative process may continue until the user accepts the generated content.

The section created may then be exported and then filled in sections on a selected template, and eventually saved as a document (e.g., a DOCX file). Optionally, after the user accepts the section, the user may save the accepted sections of the session to a local session memory, load all the sections, fill in the sections on a selected template, and eventually save as a document (e.g., a DOCX file). In some embodiments, the generated policy document may incorporate user-specific data along with general policy templates, creating customized policy documents tailored to the user’s specific requirements. The generated policy documents may be editable documents, allowing users to modify the generated documents based on their specific needs and what they want to achieve. This enables users to adapt the documents to be more custom to their usage.

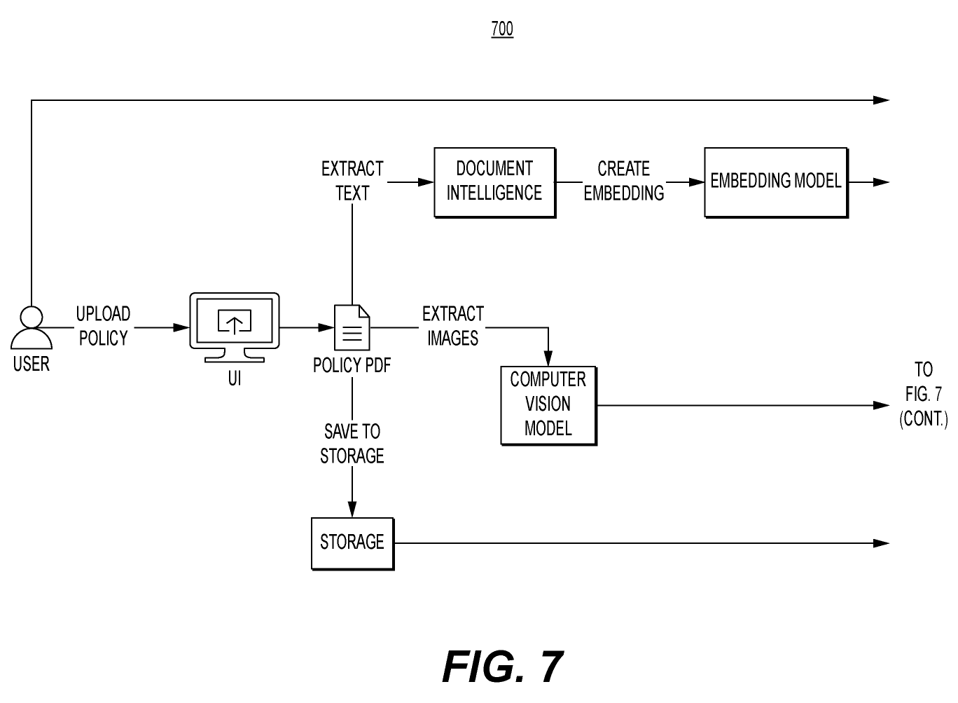

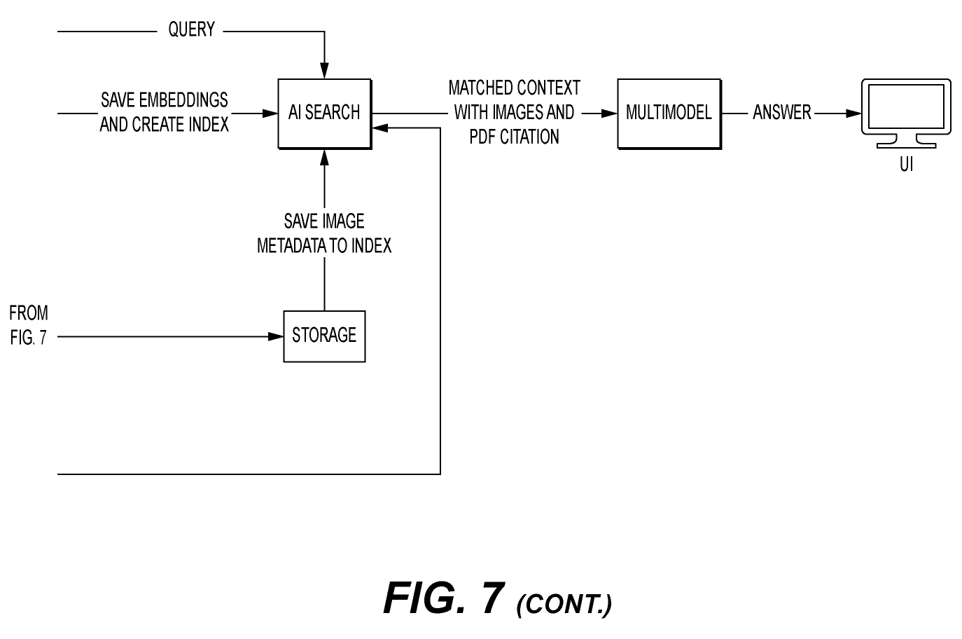

FIG. 7 depicts a flow diagram 700 for uploading policies, rules, and/or KB articles to the system described herein according to one or more embodiments. For examples, this process may describe how policies may be uploaded via a user interface, saved into storage directly, saved as an image, and further analyzed. For example, the rules, policies, and KB articles may have the text extracted and embeddings may be created. These embeddings may be saved to a database. These vectors may be what a user search is compared to at step 345 in the vector search.

In some embodiments, when the user uploads a policy document, such as a policy PDF, the uploaded document may proceed along one or more of three processing paths. In a first path, the system performs extract text on the policy PDF. The extracted text is then provided to a document intelligence component, which processes the text content of the document. Output from the document intelligence component is then used to create embedding, for example by generating a vector representation of the extracted text using an embedding model. The resulting embedding may then be used to save embedding and create index, thereby storing the embedding and associating it with an index for later retrieval. The indexed embedding is then made available to AI search.

In a second path, the uploaded policy PDF may undergo extract images. The extracted images are then provided to a computer vision model, which processes image content from the policy PDF. Output from the computer vision model may then be provided to storage, and image-related information may be used to save image metadata to index. The indexed image metadata is then made available to AI search.

In a third path, the uploaded policy PDF or associated content may be provided directly to storage. Content saved to storage may also be made available to AI search, thereby permitting the AI search component to access stored material even apart from the text-extraction and image-extraction paths.

Accordingly, FIG. 7 shows that AI search may receive input from multiple sources. In some embodiments, AI search may receive a direct query from the user. AI search may also receive indexed text-derived embeddings generated from the extract-text path, indexed image metadata generated from the extract-images path, and stored content from the storage path. In this way, AI search is able to search across multiple forms of document-derived information.

The output of AI search is provided as matched context with images and PDF citation. In some embodiments, the matched context may include relevant text, corresponding images, and citation information identifying the source PDF from which the context was obtained. The matched context is then provided to a multimodal component, which is configured to process multiple content types, such as text and images, together. Based on the matched context, the multimodal component generates an answer, which is then provided to the UI for presentation to the user.

Accordingly, FIG. 7 illustrates a pipeline in which a user may either directly query the system or upload a policy document for ingestion, after which document text, images, and stored content are processed and indexed for use by AI search, and results from AI search are used to generate an answer for display in the UI.

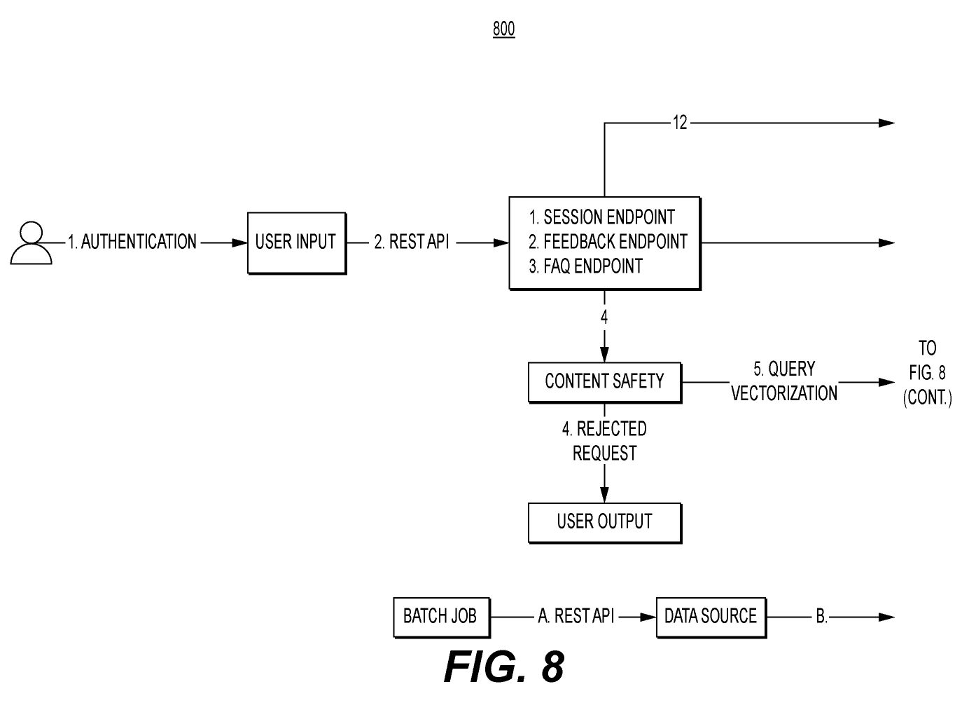

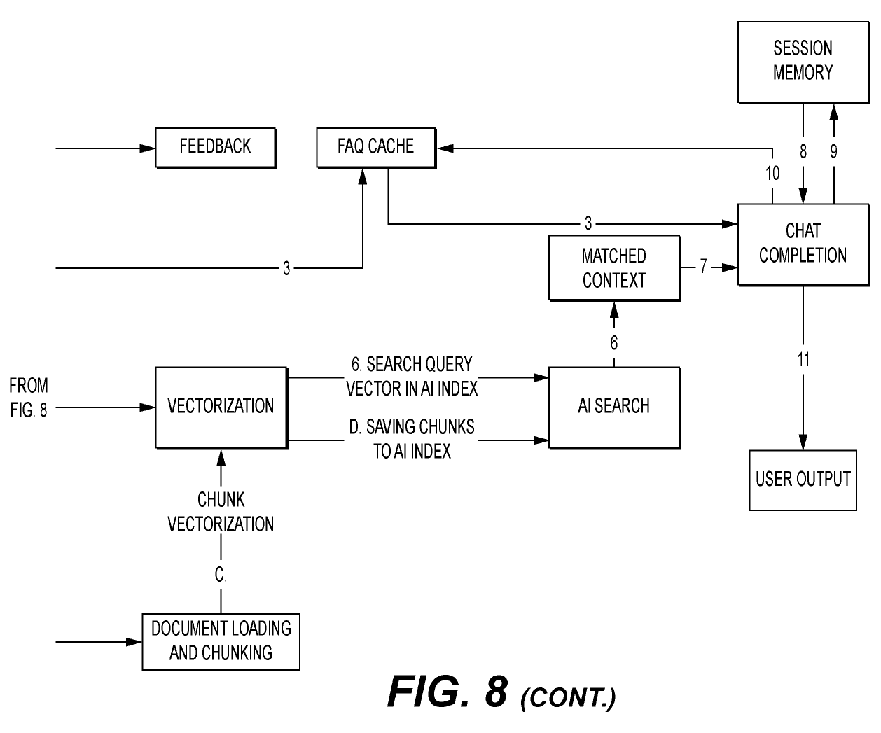

FIG. 8 depicts a flow diagram of an exemplary technology diagram, according to one or more embodiments. Technology diagram 800 may include a flow diagram with operations 1-11. The technology diagram 800 may represent an exemplary system similar to environment 200, implemented by flow diagrams 300 and 400 described herein

In some embodiments, the request-handling flow begins with user authentication, after which a user provides user input. The user input is transmitted via a REST API to a server that includes multiple endpoints, such as a session endpoint, a feedback endpoint, and a FAQ endpoint. From these endpoints, multiple processing paths are possible. In one path, the request is provided to a content safety component. If the request fails safety review, the request is treated as a rejected request and is prevented from proceeding further. If the request passes safety review, the request may proceed along a search-and-generation path in which an AI search is performed to identify relevant information from system data sources, and the results of the AI search are provided as matched context. The matched context is then supplied to chat completion, which generates a response for delivery as user output.

In another path shown in FIG. 8, data associated with the request may be routed through a FAQ cache. In some embodiments, the FAQ cache may provide cached material directly for use by chat completion, rather than requiring the full AI search path. FIG. 8 also shows a feedback path, through which feedback associated with the interaction may be provided through the feedback endpoint for storage, analysis, or future refinement of system behavior.

FIG. 8 further shows that chat completion may receive multiple inputs. In addition to the matched context produced by the AI search path, chat completion may also receive information from the FAQ cache, from session memory, and from user output associated with prior interactions. In this way, response generation may be based not only on retrieved search context, but also on cached question-and-answer material, prior session context, and prior outputs maintained by the system.

In addition to the request-handling flow, FIG. 8 also depicts a data-preparation flow. In some embodiments, a batch job provides data through the REST API to a data source. Materials from the data source are then subjected to document loading and chunking, after which the resulting chunks may be processed further, such as through embedding generation, storage, indexing, or other preparation steps used to support later search and retrieval operations. This ingestion flow provides the underlying source content used by the AI search path during live user interactions.

FIG. 9 depicts a user interface of a request input form, according to one or more embodiments. Request input form 900 may depict a user interface of a request input form for a policy document generation. The request input form may allow a user to assign a title, a number of section, and section layers of a requested output. The request input form 900 may correlate with the initial option selection in the policy generation 600 of FIG. 6. In some embodiments, the request input form may include a policy title field for entering the title of the policy document. The form may also include an output template dropdown for selecting a desired output template. In various aspects, the form may include a number of sections control with plus and minus buttons to add or remove sections. Each section layout area may include controls for subsections, images, and tables, each with plus and minus buttons to adjust the quantity of each element. Draggable components (e.g., SUB SECTION 1.1, IMAGE 1.1, TABLE 1.1) may be provided that can be arranged in order as needed in the policy document.

FIG. 10 depicts a user interface for a subsection creation request, according to one or more embodiments. Subsection creation 1000 may depict a user interface image of a subsection creation request. The subsection creation 1000 may correlate with the creating a section in the policy generation 600 of FIG. 6. In some embodiments, the interface may display an interactive conversation between the system (e.g., Treasury GPT) and the user. The system may prompt the user to enter a title for the section. Input fields may be provided for a brief description of the content needed for the subsection, keywords to include in the subsection (separated by comma), and an estimated word count (length). Generated content may be displayed, and the user may reject the generated content and provide comments in a next prompt to improve the content. A split into paragraph option may reformat the content into a paragraph structure. Upon acceptance, the subsection may be saved in memory for exporting later.

FIG. 11 depicts a user interface for an image creation request, according to one or more embodiments. Image creation 1100 may be an image of a user interface of an image creation request. The image creation 1100 may correlate with the section content generation including images in the section creation via open AI multi-model in the policy generation 600 of FIG. 6. In some embodiments, the system may prompt the user whether to upload or create an image. If the user selects create, input fields for a brief description and size may be provided. The system may generate an image based on the user’s description. An option to convert to greyscale may be provided. The user may reject the generated image and provide comments in a next prompt to improve the image, or accept the image to save it in memory for exporting later.

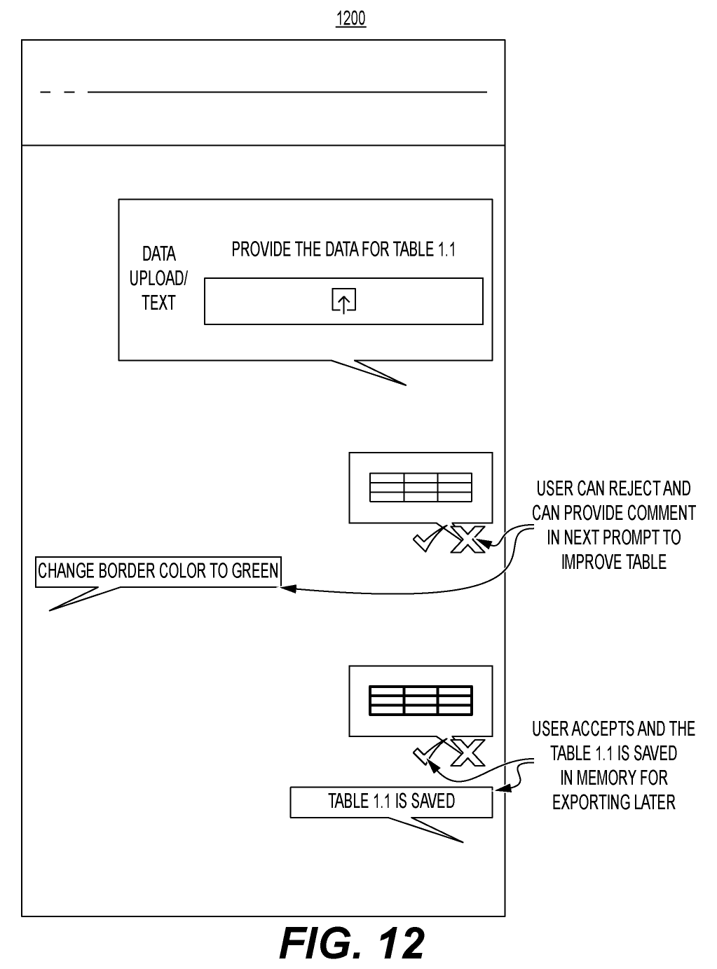

FIG. 12 depicts a user interface of a table creation request, according to one or more embodiments. Table creation 1200 may be an image of a user interface of a table creation request. The table creation 1200 may correlate with the section content generation including tables in the section creation via open AI multi-model in the policy generation 600 of FIG. 6. In some embodiments, the interface may include a data upload area where the user can provide data for the table. Table previews may be displayed with accept and reject options. The user may reject the generated table and provide comments in a next prompt to improve the table. Upon acceptance, the table border color may change (e.g., to green) to indicate acceptance, and the accepted table may be saved in memory for exporting later.

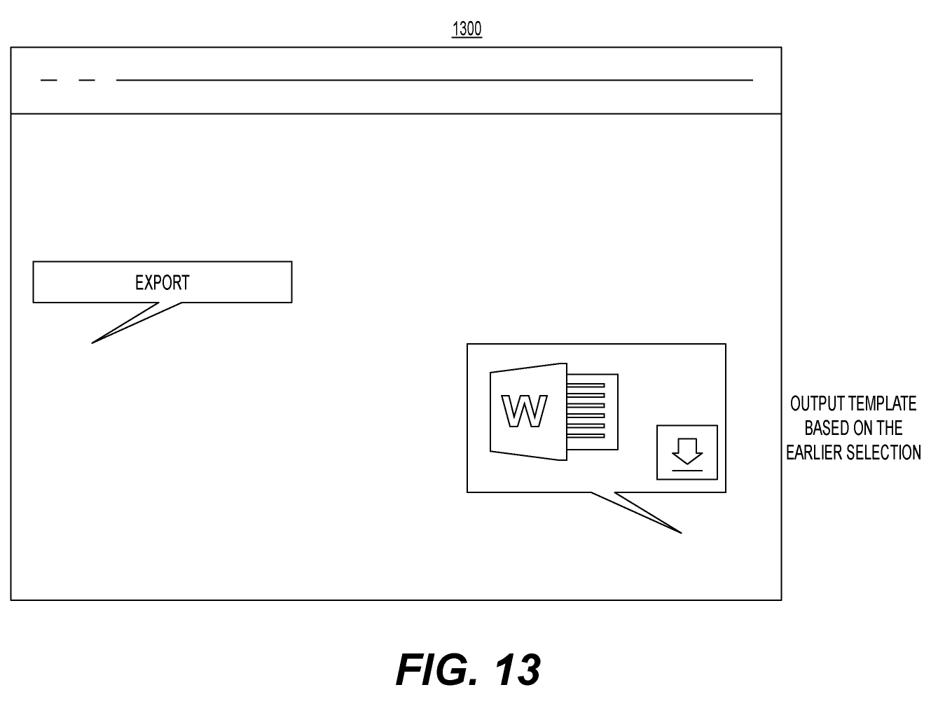

FIG. 13 depicts a user interface of a policy export request, according to one or more embodiments. Policy export 1300 may be an image of a user interface of a policy export request. The policy export 1300 may correlate with the policy export in the policy generation 600 of FIG. 6. In some embodiments, the interface may include an export button. The output template may be based on the earlier selection made by the user. The document may be exported in a word processing document format (e.g., DOCX). A download icon may indicate the ability to download the generated policy document based on user selections made in previous steps of the policy generation process.

A machine-learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine-learning model (e.g., a trained model) based on the training. Once trained, the machine-learning model may output machine-learning model outputs in accordance with the subject matter disclosed herein. According to an implementation, one or more machine-learning models disclosed herein may continuously update based on feedback associated with use or implementation of the machine-learning model outputs.

It should be understood that aspects in this disclosure are exemplary only, and that other aspects may include various combinations of features from other aspects, as well as additional or fewer features.

In general, any process or operation discussed in this disclosure that is understood to be computer-implementable, such as the processes illustrated in the flowcharts disclosed herein, may be performed by one or more processors of a computer system, such as any of the systems or devices in the exemplary environments disclosed herein, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices disclosed herein. One or more processors of a computer system may be included in a single computing device or distributed among a plurality of computing devices. A memory of the computer system may include the respective memory of each computing device of the plurality of computing devices.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed aspects may be applicable to any environment, such as a desktop or laptop computer, an automobile entertainment system, a home entertainment system, etc. Also, the disclosed aspects may be applicable to any type of Internet protocol.

It should be appreciated that in the above description of exemplary aspects of the invention, various features of the invention are sometimes grouped together in a single aspect, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed aspect. Thus, the claims following the Detailed Description are hereby expressly incorporated into this Detailed Description, with each claim standing on its own as a separate aspect of this invention.

Furthermore, while some aspects described herein include some but not other features included in other aspects, combinations of features of different aspects are meant to be within the scope of the invention, and form different aspects, as would be understood by those skilled in the art. For example, in the following claims, any of the claimed aspects can be used in any combination.

Thus, while certain aspects have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Operations may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for report generation, the method comprising:
receiving, from a user, a request to generate a report;
determining, by one or more processors, whether the request received is a valid request;
executing, by the one or more processors, at least one of a lexical search and a vector search of the request on a knowledge based storage database to determine a relevant data object;
generating, by a machine learning model, a client report based on the relevant data object; and
transmitting, to a user interface by the one or more processors, the client report.

2. The computer-implemented method of claim 1, further including:
determining whether a similar request has been previously received by the one or more processors, based on a request history; and
upon determining that the request has been previously been received, executing the at least one of the lexical search and the vector search is bypassed, and a previously generated client report is retrieved and transmitted as the client report.

3. The computer-implemented method of claim 1, further including:
determining whether the user has made a previous request to generate a report;
if a previous request was generated, retrieving a session history from storage; and
providing the session history to the machine learning model, the machine learning model incorporating the session history when generating the client report.

4. The computer-implemented method of claim 3, wherein upon a determination that the user has not made a previous request to generate the client report, creating a new session for the user.

5. The computer-implemented method of claim 1, wherein executing the at least one of the lexical search and the vector search further includes:
generating, by the machine learning model, a search query based on the request and any past requests from the user, wherein the machine learning model uses the search query to perform the lexical search and vector search.

6. The computer-implemented method of claim 1, wherein if the lexical search and vector search of the request on the knowledge based storage database returns no result, transmitting to the user interface a response indicating no answer can be found and not transmitting the client report.

7. The computer-implemented method of claim 1, further including:
identifying a count of how many times the request or a similar request has been made to the one or more processors; and
if the count exceeds a threshold value, storing the request with the client report to the knowledge based database.

8. The computer-implemented method of claim 1, further including:
requesting a feedback response from the user about the client report after the transmitting the client report.

9. The computer-implemented method of claim 1, wherein determining whether the request received is a valid request includes determining whether the request includes harmful content.

10. The computer-implemented method of claim 1, wherein the determining whether the request includes harmful content includes identifying text in the request related to sex, hate, self-harm, or violence.

11. A system for report generation, the system comprising:
a memory having processor-readable instructions stored therein; and
at least one processor configured to access the memory and execute the processor-readable instructions to perform operations including:
receiving, from a user, a request to generate a report;
determining, by one or more processors, whether the request received is a valid request;
executing, by the one or more processors, at least one of a lexical search and a vector search of the request on a knowledge based storage database to determine a relevant data object;
generating, by a machine learning model, a client report based on the relevant data object; and
transmitting, to a user interface by the one or more processors, the client report.

12. The system of claim 11, further including:
determining whether a similar request has been previously received by the one or more processors, based on a request history; and
upon determining that the request has been previously been received, executing the at least one of the lexical search and the vector search is bypassed, and a previously generated client report is retrieved and transmitted as the client report.

13. The system of claim 11, further including:
determining whether the user has made a previous request to generate a report;
if a previous request was generated, retrieving a session history from storage; and
providing the session history to the machine learning model, the machine learning model incorporating the session history when generating the client report.

14. The system of claim 13, wherein upon a determination that the user has not made a previous request to generate the client report, creating a new session for the user.

15. The system of claim 11, wherein executing the at least one of the lexical search and the vector search further includes:
generating, by the machine learning model, a search query based on the request and any past requests from the user, wherein the machine learning model uses the search query to perform the lexical search and vector search.

16. The system of claim 11, wherein if the lexical search and vector search of the request on the knowledge based storage database returns no result, transmitting to the user interface a response indicating no answer can be found and not transmitting the client report.

17. The system of claim 11, further including:
identifying a count of how many times the request or a similar request has been made to the one or more processors; and
if the count exceeds a threshold value, storing the request with the client report to the knowledge based database.

18. The system of claim 11, further including:
requesting a feedback response from the user about the client report after the transmitting the client report.

19. The system of claim 11, wherein determining whether the request received is a valid request includes determining whether the request includes harmful content.

20. A non-transitory computer readable medium storing processor-readable instructions which, when executed by at least one processor, cause the at least one processor to perform operations including:
receiving, from a user, a request to generate a report;
determining, by one or more processors, whether the request received is a valid request;
executing, by the one or more processors, at least one of a lexical search and a vector search of the request on a knowledge based storage database to determine a relevant data object;
generating, by a machine learning model, a client report based on the relevant data object; and
transmitting, to a user interface by the one or more processors, the client report.
